(19) United States
(12) Patent Application Publication
(10) Pub. No.: US 2010/0049914 A1
(43) Pub. Date: Feb. 25, 2010

(54) RAID Enhanced solid state drive

(76) Inventor: Paul M. Goodwin, Austin, TX (US)

Correspondence Address: Paul Goodwin, Suite 500, 9517A Bumet Rd., Austin, TX, 78758, US

(21) Appl. No.: 12/229,137

(22) Filed: Aug. 20, 2008

(51) Int. Cl. G06F 12/00

(52) U.S. Cl. 711/114

(57) ABSTRACT

The present invention relates to a solid-state storage subsystem which comprises a plurality of solid state drive designs integrated with a storage processor that provides performance, data integrity and reliability improvements in a standard disk drive form factor with a standard disk drive interface.

### TECHNICAL FIELD

The present disclosure relates to a mass storage device. More particularly, the disclosure relates to a solid-state mass memory storage sub-system integrated in a standard drive form factor suitable for disk drive replacement.

### BACKGROUND OF THE INVENTION

As the volume of data generated by computing devices increases so has the importance of accessing the data quickly and accurately. Exacerbating the problem of the fast and reliable access to data is the power required, not only to access the data, but just keeping it online available to access.

For over 50 years the Hard Disk Drive (HDD) has been the staple of online mass storage. Technological advances have made great strides in increasing the density of the data stored on the HDDs and the speed in which data can be transferred from the hard disk to the host system or controller. However, with these advances other problems have appeared.

Reliability, Data integrity and Power are significant problems for the managers of data bases and data storage systems, while the performance of even the largest storage systems haven't kept pace with the demand.

The reliability of HDDs has always been an issue. The heart of the HDD is one or more rotating disks with a coating of a magnetic medium. Relying on moving parts is fraught with peril. Relying on a mechanism that is rotating at up to 15,000 rotations per minute and running at that speed for 24 hours a day, 7 days a week is a lot to ask. This is complicated by having a mechanical actuator that positions the magnetic read-write devices over the rotating disks which is subject to friction and wear. Given the number of potential failure modes of the HDD is of little surprise that many storage sub-system managers replace drives on an annual basis at a great expense in time and money as well as system downtime to prevent an unscheduled downtime.

Data integrity has always been a concern in HDDs. HDD manufacturers have always allocated a percentage of the available data holding capacity of a HDD to error checking and correcting. The error checking and correcting algorithms write redundant information on the storage medium in order to recover data lost due to either being mis-read (soft error) or an error in the stored data (hard error). Soft errors can be due to a variety of factors such as mechanical wear on the actuator that position the read heads or mis-alignment due to vibration from installing a number of HDDs together in a system. Hard errors can be caused by the physics of storing so many bits so close together on the platters or by writing data over adjacent bits due to mechanical misalignment of the write heads.

The most significant problem of all may be the power required to operate the drive. It takes power to keep the platters rotating so that data can be accessed on the HDD. It takes more power to move there read-write heads into position to read or write the data and it take power to drive the electronics to correct hard and soft data errors.

To make matters worse many HDD based storage systems use many more disks than necessary to provide the required storage capacity because the performance of the number of drives needed to supply the capacity cannot provide the performance in Input output per second (IOPS) that the compute server requires.

A typical strategy to address the reliability and data integrity issues that are more severe than the ECC implementation can recover from is to use a Redundant Array of Inexpensive Disks. The Redundant Array of Inexpensive disks or RAID is a strategy that is well known in the art and is based on the paper The case for redundant arrays of inexpensive disks (RAID—Patterson, Gibson, et al.—1988. In this strategy redundant information is stored on additional drives so that if one drive fails the information is available on another drive. While RAID does a good job of protecting against data loss and down time it requires additional drives and thus additional power. One significant drawback to employing a RAID strategy is that not all RAID controllers are the same. RAID controllers may not put data in the same place in a RAID array.

Solid State Disks (SSD) have been around since the mid 1980s but have only recently had widespread acceptance in the market. SSDs offer high-performance and low-power without the reliability concerns because there are no moving parts.

SSDs do have the advantage of performance and power over the traditional HDD. Also today's SSDs look very much like a HDD. They have the same interface, the same function and the same form factor. However, looks can be deceiving. Take the cover off of a SSD and the first thing that one should notice is what an incredible waste of space. SSDs are being packaged in the same envelope as traditional HDDs which can be significantly larger than the envelope necessary to package the number of solid state devices to provide the desired capacity.

SSDs will likely continue to be packaged in the same form factor enclosure as HDDs well into the future. This is because SDDs are not going to replace HDDs as the HDDs have a cost per bit advantage over the SDDs. So the opportunity that is not being addressed in the industry is what to do with the space available in the SSD enclosure.

The performance of the SSDs, while greater than the HDDs, Is not keeping up with the performance of the interface. Today the SATA interface is up to 3 Gbs and migrating towards 6 Gbs. The fastest SSDs are significantly slower than the interface that it uses to connect to a system. Thus there is excess bandwidth available on the cable or undersubscribed bandwidth.

The under subscription of the interconnect is exacerbated in a RAID configuration. Now there are multiple cables connecting the RAID controller to the number of the drives in the RAID strategy.

A means of concentrating the bandwidth from a number drives in a RAID or concatenated configuration exist by placing a port multiplier between the computer and the disk drives in the RAID configuration. However this topology does not reduce the number of cables. Using a port multiplier increases the number of cables as well as adding an additional piece of hardware in the topology.

From the foregoing, it can be appreciated that it would be desirable to have a greater featured, mass memory storage device that takes advantage of the available volume from implementing an SSD in an standard HDD physical envelope.

### SUMMARY OF THE INVENTION

The present disclosure relates to a solid-state mass memory storage subsystem. The solid-state mass memory subsystem comprises one or more printed circuit assemblies and a plurality of nonvolatile, high density storage devices mounted to the printed circuit assembly and electrically connected thereto. The solid-state memory subsystem includes at least one controller mounted to the one or more printed circuit assembly and electrically connected thereto, and a connector mounted to the printed circuit assembly and electrically connected thereto, the connector being adapted to electrically connect the solid-state mass memory storage device to a separate electronic device.

In one embodiment, the solid-state mass memory storage subsystem has a form factor equivalent to a conventional disk drive and the at least one controller includes control electronics and firmware which emulate a RAID controller and control electronics and firmware which emulate two or more disk drives such that the device in which said solid-state mass memory storage subsystem will interpret and treat the solid-state mass memory storage subsystem as a RAID array. With such an arrangement, the solid-state mass memory device can be used as a disk drive replacement.

In another embodiment, the high density storage devices are removable mounted in storage device sockets formed in said printed circuit assembly in a redundant array.

The features and advantages of the invention will become apparent upon reading the following specification, when taken in conjunction with the accompanying drawings.

### BRIEF DESCRIPTION OF THE DRAWINGS

FIG. 1 Depicts a conventional SSD

FIG. 2 shows the mechanical drawing for a disk drive package.

FIG. 3A Depicts a block Diagram of a conventional SSD that uses a single bus protocol to flash controller device

FIG. 3B Depicts a block Diagram of a conventional SSD that uses a bus protocol bridge and a Bus protocol to flash controller device

FIG. 4 depicts a physical embodiment of the SSD of FIG. 3 in a reduced form factor.

FIG. 5 depicts a typical 2.5″ drive enclosure and the volume required to implement the SSD of FIG. 4.

FIG. 6 Depicts a block diagram of a RAID enhanced SSD using a 2-port RAID Controller.

FIG. 7A Depicts a RAID enhanced SSD using plug-in instances of a SSD implementation.

FIG. 7B Depicts a RAID enhanced SSD implemented on a single module.

FIG. 8 Depicts a block diagram of a RAID enhanced SSD using a 5-port RAID Controller.

FIG. 9 depicts a physical implementation of the alternate embodiment of a RAID enhanced SSD of FIG. 8.

FIG. 10 depicts a module for interconnecting a control module and a plurality of SSD modules.

FIG. 11 Depicts the interconnect topology of a typical computing system.

FIG. 12 Depicts the interconnect topology of an exemplary port multiplier or RAID configuration of a typical computing system.

FIG. 13 Depicts the interconnect topology of a system with an exemplary RAID configuration.

FIG. 14 Depicts the interconnect topology of a system using a RAID Enhanced SSD

FIG. 15 Depicts a typical system with a conventional SSD connected to a HBA.

FIG. 16 Depicts a typical system with a set of conventional SSDs connected to a, internal RAID Controller.

FIG. 17 Depicts a typical system with a set of conventional SSDs connected to an external RAID controller or Port multiplier.

FIG. 18 Depicts a typical system with a set of conventional SSDs connected to an external Storage Subsystem with a RAID controller or Port multiplier interface.

FIG. 19 Depicts a typical system with a RAID enhanced SSDs connected to a HBA.

FIG. 20 depicts the block diagram of a 2-port RAID enhanced SSD with a protocol bridge

FIG. 21 depicts the block diagram of a 5-port RAID enhanced SSD with a protocol bridge

### DESCRIPTION OF PREFERRED EMBODIMENT

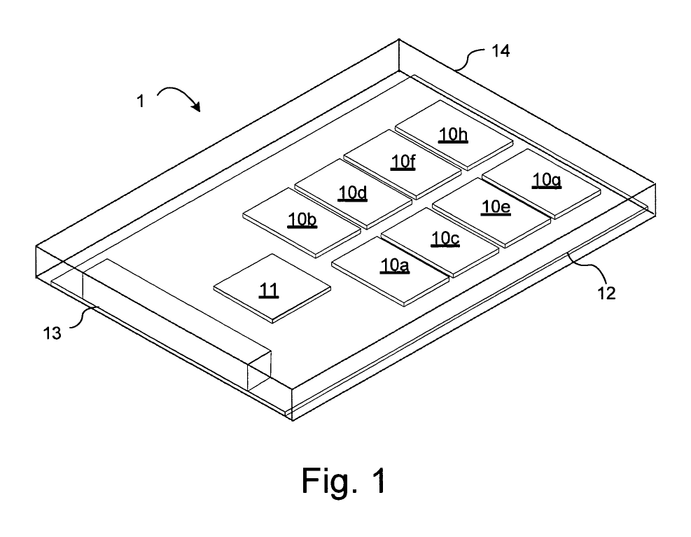

FIG. 1 depicts a conventional SSD 1 showing the five elements that comprise a SSD 1 are shown. These elements are: the SSD Controller 11, one or more non-volatile storage components 10a-10h, connector 13 for connecting the SSD 1 to a host controller, the printed Circuit Board (PCB) 12 on which the above components are disposed and an enclosure 14 that is shown in wire frame.

Multiple capacities may be realized by populating the array of non-volatile devices 10a-10h with fewer devices than the number of available mounting sites or by populating the array of non-volatile devices 10a-10h with more devices than the number of available mounting sites by utilizing multiple die packages (MDP) or stacks of monolithic devices. Additionally different capacities can be realized by populating the SSD 1 with non-volatile devices 10a -10h of various densities.

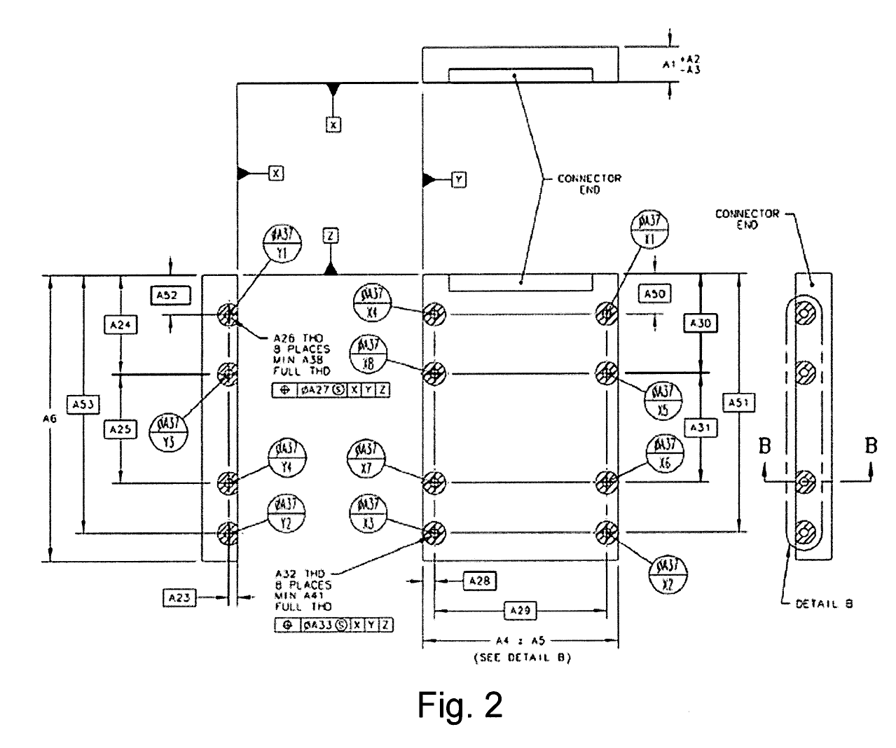

The form factor for the SSD 1 shown in FIG. 2 is the industry standard 2.5″ disk drive form factor defined by the Small Form Factor Committee (SFF) of the Electronics industry association (EIA). The form factor is a common form factor for both HDDs and SSDs. Nearly all SSDs use this form factor as it is the most widely used form factor in computers. While the physical volume necessary to implement a HDDs defines the envelope SSDs use the common form factor in order to fit in existing slots for mounting storage drives typically referred to as a drive bay.

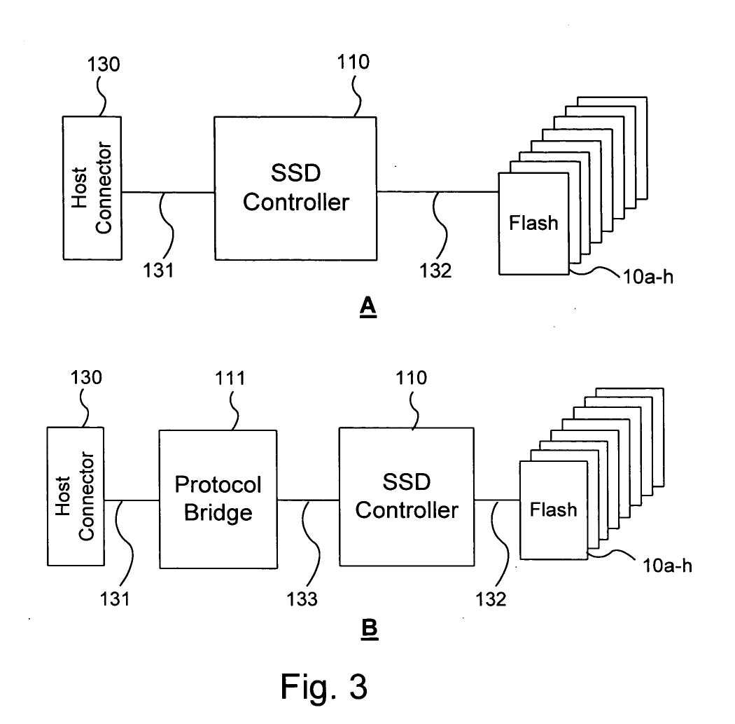

Block Diagrams for the SSD 1 are shown in FIG. 3. The Block Diagram of FIG. 3A depicts the generic implementation of a SSD 1 with the connector 130 that connects the interface port of the SSD Controller 110 to the host interface over the link 131. The SSD controller 110 receives commands and exchanges data from link 131 and translates the commands into operations on the Flash array 10a-10h over a flash interface 132. The flash interface 132 may be a single channel of command and data signals or multiple channels with multiple command and data interfaces.

An alternate black diagram is shown in FIG. 3B where the SSD Controller 110 is has a different host interface protocol than is desired for the embodiment. Between the host interface connector 130 and the SSD Controller 110 is a protocol bridge 111. The protocol bridge 111 converts the host interface protocol from the host interface connector 130 into the native protocol that the SSD controller 112 communicates to a host with. The SSD controller 110 then receives commands and exchanges data from link 133 and translates the commands into operations on the Flash array 10a-10h over a flash interface 132.

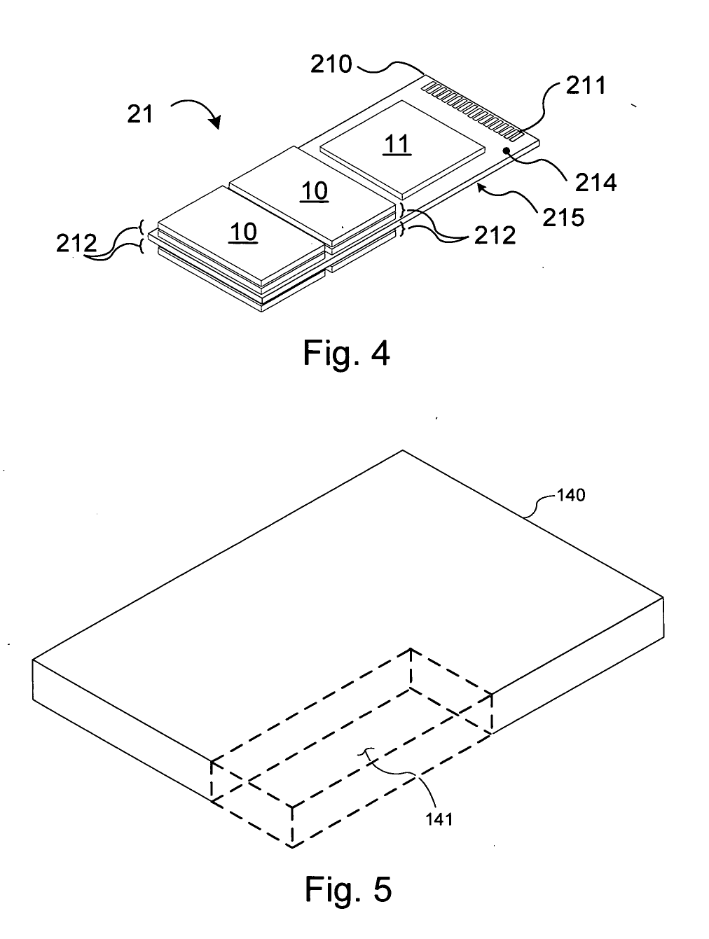

Depicted in FIG. 4 is an exemplary embodiment of how small a SSD implementation could be and still achieve maximum capacity. The dimensions of the PCB 210 to provide sufficient area to mount the SSD controller 11, an edge finger connector 211 and four sites for mounting non-volatile memory devices 10 is approximately 25 mm wide by 52 mm long. In order to get the maximum capacity of the non-volatile memory devices 10 four footprints is not sufficient so the stacking of non-volatile memory packages 212 is required. The stacks of non-volatile memory 212 on the upper surface 214 and the stacks of non-volatile memory 212 on the bottom surface 215 of the PCB 210 and the thickness of the PCB 210 itself add up to approximately 5 mm. These results in a volume required to implement a SSD of approximately 12.5 cm³.

In FIG. 5 the typical 2.5″ Drive form factor 140 is shown. The dimensions of the drive enclosure 140 of FIG. 2 are 70 mm wide by 100 mm long As specified by Small Form Factor Committee (SFF) of the Electronics industry association (EIA). The thickness of the SSDs that are used in notebook computers is 9.5 mm max. Thus the volume of the envelope of a 2.5″ notebook drive is 66.5 cm³.

With the volume of the minimum form factor SSD 21 from FIG. 4 being 12.5 cm³ that means that the Enclosure envelope of the typical notebook SSD is over five times the volume required to implement the SSD of FIG. 4. It is in the excess volume that the present invention shall be implemented. The Volume of drive enclosure 140 that is required for the minimum form factor SSD 21 from is highlighted by the dashed line wire frame 141.

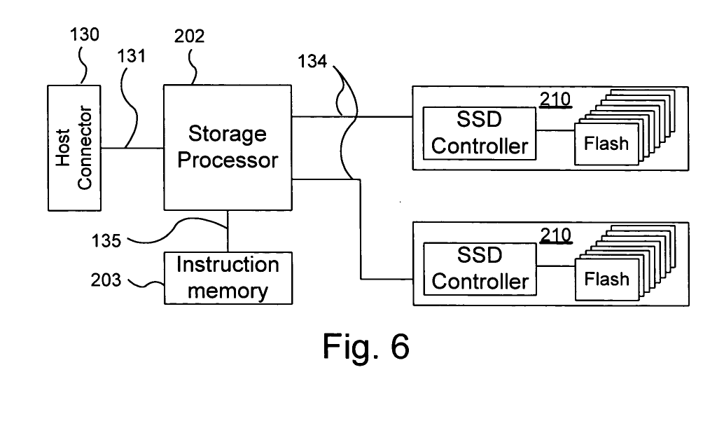

The present invention takes advantage of the volume of the drive enclosure 140 that is not necessary to implement the SSD 1 of FIG. 1 by adding components that will provide additional features not previously available in the form factor and by increasing capacity to offer capacities not previously available in the form factor. The block diagram for the present invention implementing a RAID enhanced SSD is shown in FIG. 6. In this block diagram there are two instances of the SSD 1 block diagram from FIG. 3. This could be the single SSD controller 110 of FIG. 3A or the SSD controller 110 and Protocol Bridge 111 of FIG. 3B. There is also a Host connector 130 as with the block diagram from FIG. 3. The present invention utilizes a Storage processor 202 to link the two SSD instances 210 via links 134 to the host connector 113 over link 131. The storage processor 202 executed instructions stored in processor instruction memory store 203 that it accesses via link 135.

With two SSD 210 instances the storage processor 202 is capable of RAID strategies that use two drive instances. These strategies are: RAID-0, RAID-1, JBOD, BIG as well as hybrid modes that combine two or more of the strategies. These RAID stratagies are well known to those with skill in the art.

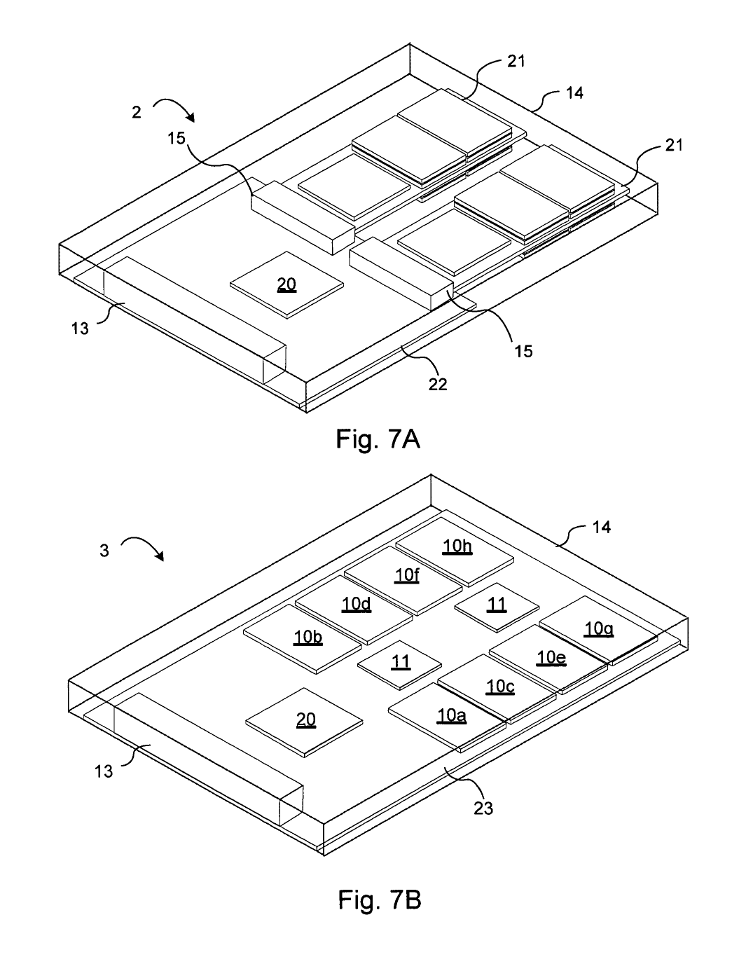

FIG. 7A depicts the present invention of a RAID enhanced SSD 2. The embodiment uses two small modules 21 on which the SSD 1 of FIG. 3 is implemented. The SSD 21 modules are plugged into a controller module 22 via connectors 15. The controller module 22 supports the interface connector 13. The two modules are connected to the host connector 13 through the storage processor 20.

FIG. 7B depicts an alternate embodiment of a RAID enhanced SSD 3. The RAID Enhanced SSD 3 is implemented on a planar module instead of the individual modules 21.

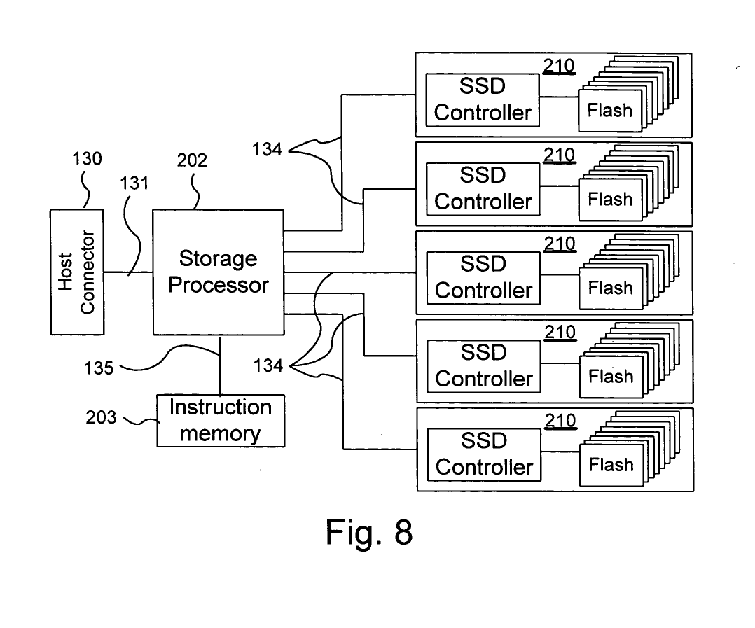

FIG. 8 is the block diagram of anther alternative embodiment of the present invention 2. In this alternative embodiment there are five instances of the SSD 1 of FIG. 3. The 2-port storage processor 20 of is replaced with a 5-port storage processor 20.

With 5 SSD 210 instances and a 5-port controller 202 there are additional RAID strategies that can be utilized. In addition to the modes-RAID-0, RAID-1, JBOD, BIG-of the 2-port storage processor the 5 port storage processor 202 can provide RAID 5, RAID 6, RAID 10 as well as hybrid strategies and strategies that can utilize hot spares. Hot Spares are installed instances of the SSD 210 that are not in use. When a Fault is detected in one of the installed drives that is in operation the storage processor 20 can rebuild the data on the faulty drive on the hot spare and then reconfigure the sub-system so that the hot spare is now an active drive.

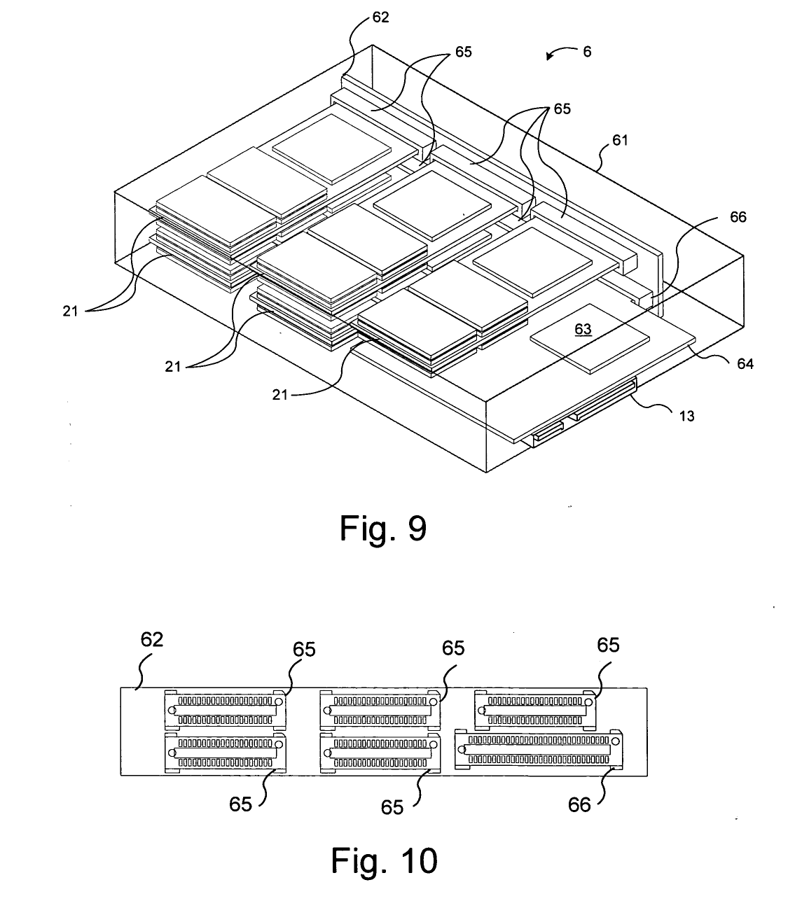

FIG. 9 depicts a physical implementation of the alternative embodiment of FIG. 8. In this alternative embodiment small modules 21 that have the SSD of FIG. 3 implemented on them are plugged into a backplane 62. The backplane 62 has five sockets 65 to receive modules 21. Additionally there is a socket 66 to receive a controller module 60 that comprises a PCB 64, a storage processor 63 and a interface connector 13.

FIG. 10 shows a plan view of the backplane 62 of the alternative embodiment of FIG. 9. In this view the five sockets 65 for minimal form factor SSD 21 and the socket 66 for the controller module are shown mounted on the backplane 62.

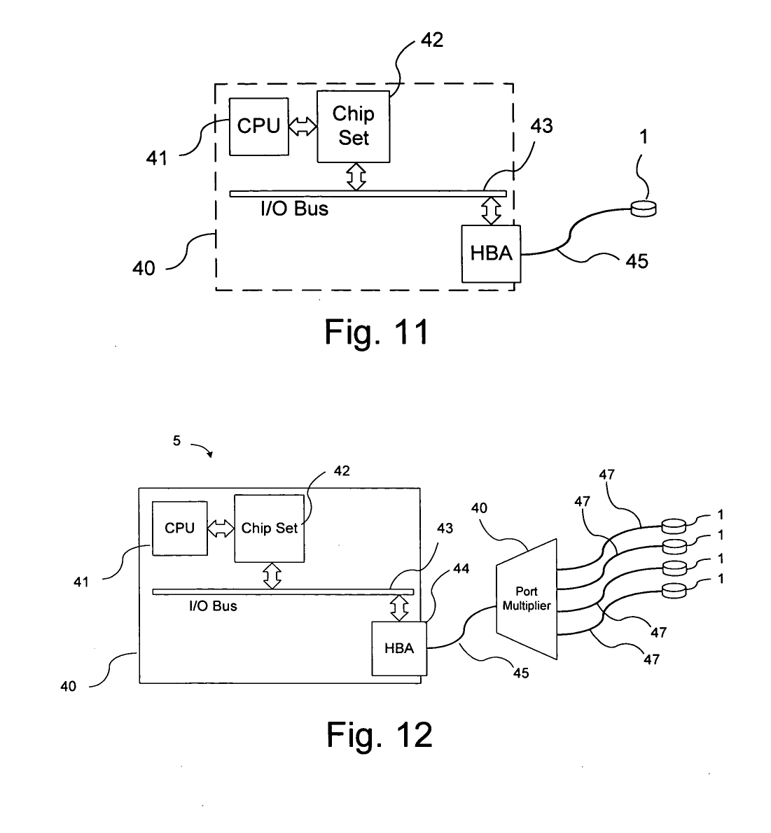

FIG. 11 shows the topology of a typical computing system. The system comprises a mother board 40 on which the major elements are disposed. The major elements are a CPU 41, a Interface chip set 42 and a host bus adapter (HBA) 44 that is connected to the chip set 42 via an I/O bus 43. The HBA 44 may be a module that plugs into a socket on the motherboard 40 or may be a chip disposed on the motherboard 40.

Connected to the HBA 43 via a cable 45 is a SSD 1.

FIG. 12 depicts another common topology for SSDs 1 in a computer system. In this topology an external controller 40 is connected to the HBA 44 via cable 45. Connected to the external controller 40 are multiple SSDs 1 each with an interface cable 47. An advantage of this topology is that multiple SSDs 1 can be connected to the HBA 44. This topology also concentrates the bandwidth of the multiple SSDs 1 so that the utilization of the bandwidth on the cable 45 is greater than could be achieved by a single drive.

The external controller 40 may perform several different functions. A simple function that the external controller can perform is acting as a port multiplier. In this function the controller allows a plurality of drives to be connected to a single port on an HBA 44. More complex functions that this external controller 40 can perform is RAID configurations.

A downside of this configuration is that the system that this configuration is implemented in requires a drive bay for each of the SSDs 1 and a space for the external controller 40. This topology is often implemented with the SSDs 1 and the external controller 40 is installed in an external chassis.

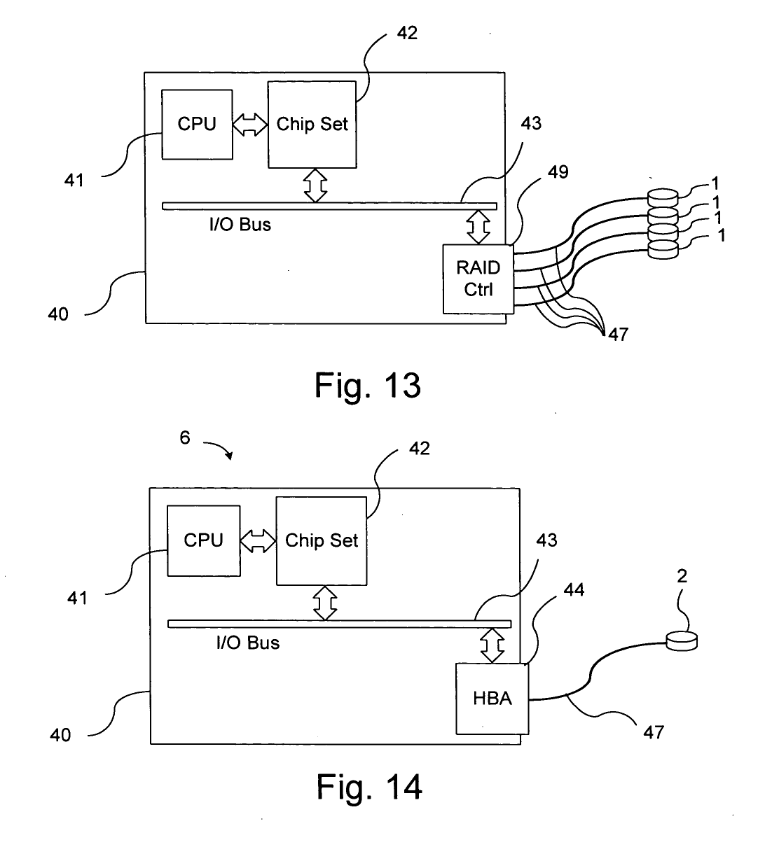

FIG. 13 shows a topology that attempts to resolve some of the issues of the topology of FIG. 12. The HBA 44 is replaced by a RAID controller 49. This eliminates the need for an external controller 40 that performs the RAID functions in addition to the HBA. There is still a requirement for multiple drive bays to hold the SSDs 1.

The topology of FIG. 14 shows a topology that utilizes the RAID enhanced SSD. This topology is the same as the topology of figure FIG. 12. However, the RAID enhanced SSD 2 has the performance and features of the storage subsystems of FIG. 12 and FIG. 13. This is due to fact that the architecture of the RAID enhanced drive as shown in FIG. 6 and FIG. 8 is the same as the topologies of FIG. 12 and FIG. 13.

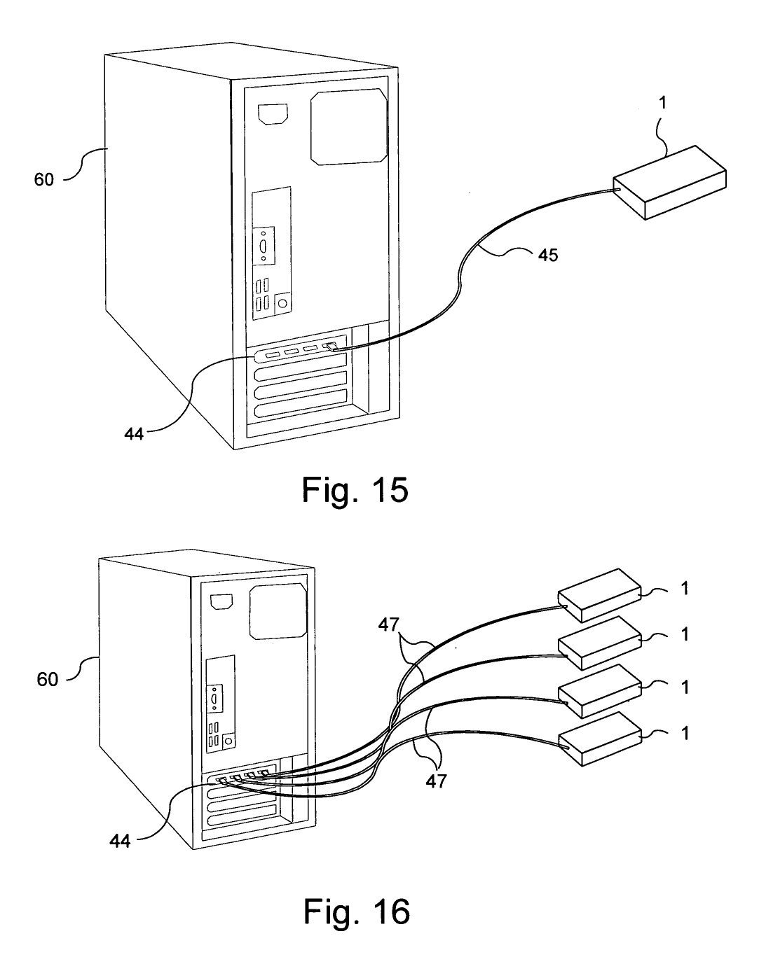

FIG. 15 shows an exemplary system of the topology shown in FIG. 11 where a SSD I is connected to a computing system 60 via cable 45 and HBA 44.

FIG. 16 Shows an exemplary system of the topology shown in FIG. 13 where multiple SSDs 1 are connected to a computing system 60 via cable 47 and HBA 44. The HBA 44 in the exemplary system could be a 4 port controller or could be a RAID controller.

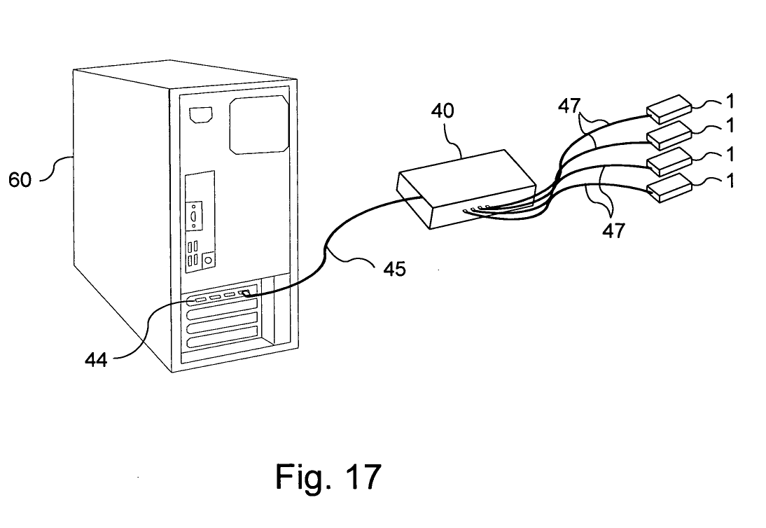

FIG. 17 shows an exemplary system of the topology shown in FIG. 12 where multiple SSDs I are connected to an external controller 40 via cables 47. The External controller 40 could be a port multiplier or a RAID controller. The external controller 40 is then connected the computing system 60 via cable 47 and HBA 44. The Cable 45 that connects the computing system to the external controller 40 may be the same type of cable 47 that connects the external controller 40 to the drives I or it may be a different type of cable. The external Controller 40, whether a Port Multiplier or a RAID controller, acts as a bandwidth concentrator. This results in the cable 45 that connects the external controller 40 to the computing system 60 carrying the combined bandwidth of the cables 47 that connect the SSDs to the external controller 40. The cables 47 are typically designed to carry the full bandwidth of the interface specification they are intended for. The full bandwidth of an interface is typically not able to be fully utilized by a single device. This may be due to the device not being fast enough to utilize the bandwidth or the access to a single device in operation less than 100%.

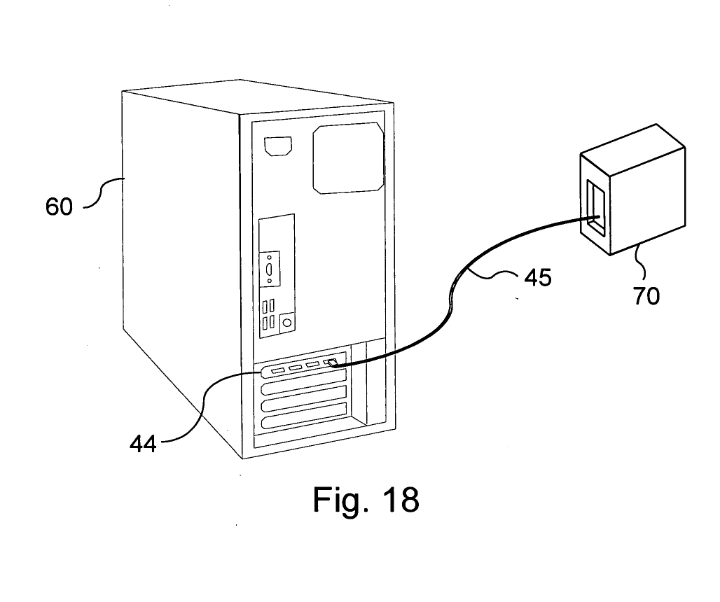

A typical embodiment of the topology of FIG. 12 and the physical components shown in FIG. 17 is shown in FIG. 18. An external chassis 70 is used house the external controller 40 that performs the port multiplier or RAID controller functions and has multiple bays in which drives are installed. The cables 47 are used internal to the chassis 48 to connect the drives I to the controller 40.

The system in the preceding figures has been shown as external components for clarity. Those skilled in the art will recognize that the components shown in the external chassis 40 may be installed in the computing system chassis ? providing that the chassis is of sufficient size to install the controller and multiple drives.

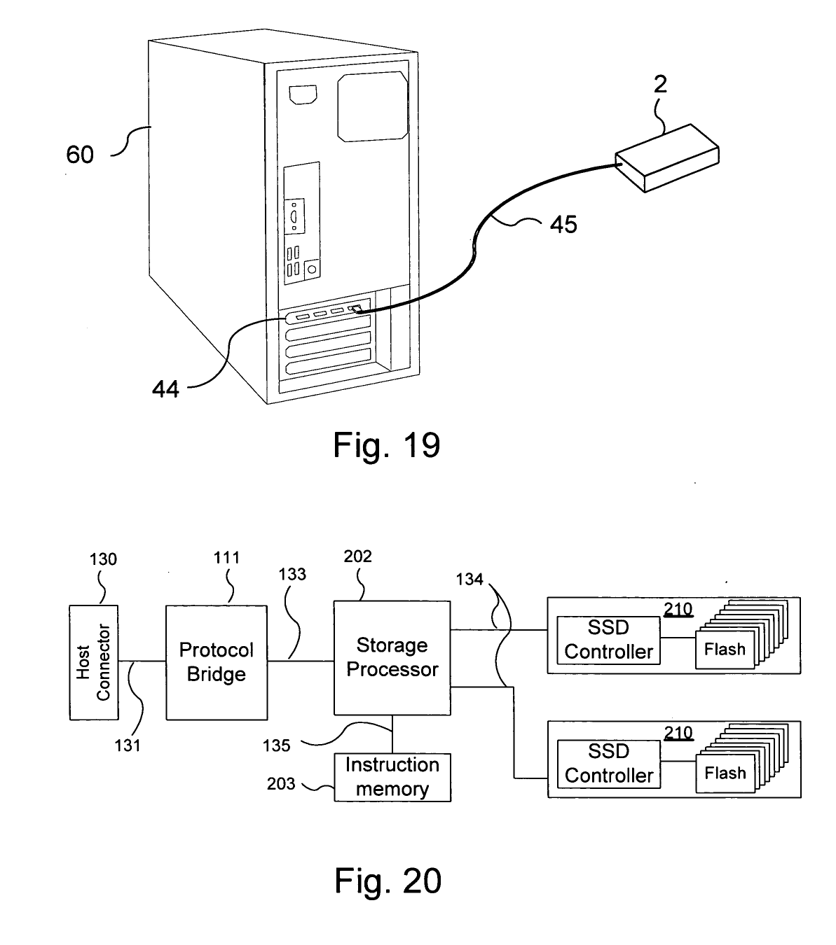

FIG. 19 shows an exemplary system with the present invention 2. The present invention 2 integrates the functions of the external controller and multiple SSDs 1, Shown in FIG. 15, FIG. 16, and FIG. 17 into a case that is the same size and form factor of a single drive 1. By integrating the multiple drives into a case the size of a single drive 1 with the external controller 40 the cables 47 are eliminated reducing the cost of the system. The reduced size of the embodiment results in shorter interconnect lengths between the controller function and the SSD instances. Those skilled in the art will recognize that the interface between the integrated SSD and the controller function may be run at a higher speed. This is due to the fact that the bandwidth of an interface is inversely proportional-to the length of the interconnect.

A single cable 45 is now the only interconnect needed to connect the present invention 2 to a host system 60. The cable 47 has the same benefits and the cable 47 in FIG. 15, FIG. 16, and FIG. 17 in that it is being used more efficiently due to carrying the bandwidth of multiple drives 1.

By integrating multiple instances of a drive 1 and controller 40 in a case that is the same form factor as a single drive 1 the present invention 2 enables smaller computing systems to achieve the capacity and performance as systems in larger chassis. Systems that may benefit from employing the present invention are small desktop systems that are known in the industry as thin clients or ultra thin clients. These systems typically only have one or two drive bays thus could not benefit from larger RAID or port multiplier configurations.

A particular class of computing system that would benefit from employing the present invention 2 would be mobile computing. Note book computers have size and weight constraints to make them convenient to carry. Because of these constraints the notebook computers only have a slot for one disk drive. Because of the one drive slot these platforms are not able to benefit from the performance and reliability offered by multiple drive RAID configurations. To realize the advantages of a RAID configuration the only options are to increase the size of the notebook computer or to use the present invention 2.

The Block Diagram of FIG. 20 is yet another embodiment of the present invention. In this alternative embodiment there is a protocol bridge 111 that is located between the storage processor 202 and the host interface 113.

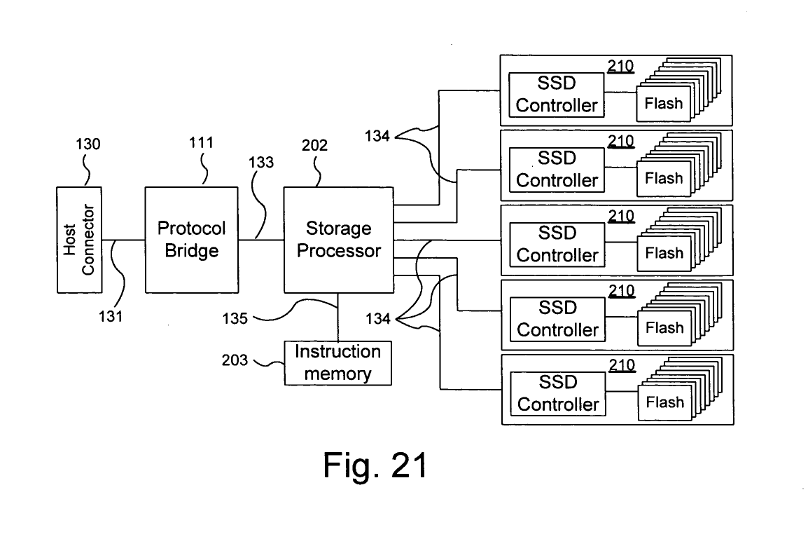

The Block Diagram of FIG. 21 is another embodiment of the present invention. In this alternative embodiment there is a protocol bridge 111 that is located between the storage processor 202 and the host interface 113.

1. A solid state mass memory storage subsystem comprising:
(a) a printed circuit module;
(b) a plurality of Solid State Drive design instances mounted on and electrically connected to said printed circuit module comprising:
i. a plurality of non-volatile memory devices and
ii. one or more controller integrated circuits electrically connected to said non-volatile memory devices with an electrical interface that is electrically equivalent to a industry standard Disk Drive interface;
(c) a storage processor with a number of industry standard Disk Drive interfaces that is equal to or greater than the number of solid state disk design instances mounted to and electrically connected to said printed circuit module;
(d) a connector mounted to said printed circuit assembly and electrically connected thereto, said connector being electrically connected to said storage processor and constructed to electrically connect said solid state mass storage device to a separate electronic device,
wherein said solid state mass storage subsystem is contained in an enclosure that has a form factor equivalent to that of a single conventional disk drive such that said storage subsystem is configured for replacing a disk drive in a computing device.

2. The device of claim 1, wherein said the number of solid state drive instances is two.

3. The device of claim 1, wherein said storage processor is configured to function as a RAID controller.

4. The device of claim 1, wherein said storage processor is configured to function as a RAID-0 controller.

5. The device of claim 1, wherein said storage processor is configured to function as a RAID-1 controller.

6. [Hybrid mode]

7. The device of claim 1, wherein said connector is for an industry standard interface that is different from said host interface of said storage processor; a protocol converter integrated circuit is disposed on said printed circuit, said protocol converter is has a first interface that is compatible with said storage processor and a second interface that is compatible with said connector, said protocol converter is electrically connected to said connector and said storage processor.

8. The device of claim 7, wherein the industry standard interface is Serial Attached SCSI (SAS).

9. The device of claim 7, wherein the industry standard interface is Serial Advanced Technology Attachment (SATA).

10. The device of claim 7, wherein the industry standard interface is Fibre Channel (FC).

11. A silicon based solid state mass memory storage subsystem comprising:
(a) a plurality of modules of a size and shape that is a reduced form factor on which a solid state drive may be implemented comprising:
i. a printed circuit module;
ii. one or more controller integrated circuits;
iii. one or more non-volatile memory devices mounted to said printed circuit module and electrically connected thereto;
iv. a connector mounted to said printed circuit module and electrically connected thereto;
(b) an interface module comprising:
i. a printed circuit module;
ii. one or more storage processors;
iii. a connector mounted to said printed circuit assembly and electrically connected thereto, said connector being electrically connected to said storage processor to interface with an external electronic device;
iv. a connector mounted to said printed circuit assembly and electrically connected thereto, said connector being electrically connected to said storage processor to interface with said plurality of solid state drive modules;
(c) a backplane module for interconnecting said controller module and said solid state drive modules comprising:
i. a printed circuit module;
ii. a connector for receiving said controller module;
iii. a plurality of connectors for receiving said solid state disk modules;
wherein said solid state mass storage subsystem is contained in an enclosure that has a form factor equivalent to that of a single conventional disk drive such that said storage sub-system is configured for replacing a disk drive in a computing device.

12. The device of claim 11, wherein said the number of solid state drive instances is five.

13. The device of claim 11, wherein said storage processor is configured to function as a RAID controller.

14. The device of claim 11, wherein said storage processor is configured to function as a RAID-0 controller.

15. The device of claim 11, wherein said storage processor is configured to function as a RAID-1 controller.

16. [Hybrid mode]

17. The device of claim 11, wherein said connector is for an industry standard interface that is different from said host interface of said storage processor; a protocol converter integrated circuit is disposed on said printed circuit, said protocol converter is has a first interface that is compatible with said storage processor and a second interface that is compatible with said connector, said protocol converter is electrically connected to said connector and said storage processor.

18. The device of claim 17, wherein the industry standard interface is Serial Atached SCSI (SAS).

19. The device of claim 17, wherein the industry standard interface is Serial Advanced Technology Attachment (SATA).

20. The device of claim 17, wherein the industry standard interface is Fibre Channel (FC).

21. A silicon based solid state mass memory storage subsystem comprising:
(a) a plurality of modules of a size and shape that is a reduced size form factor on which a solid state drive may be implemented comprising:
v. a printed circuit module;
vi. one or more controller integrated circuits;
vii. one or more non-volatile memory devices mounted to said printed circuit module and electrically connected thereto;
viii. a connector mounted to said printed circuit module and electrically connected thereto;
(b) an interface module comprising:
i. a printed circuit module;
ii. one or more storage processors;
iii. a connector mounted to said printed circuit assembly and electrically connected thereto, said connector being electrically connected to said storage processor
iv. a plurality of connectors mounted to said printed circuit assembly and electrically connected thereto, said connector being electrically connected to said storage processor and used for receiving said solid state drive modules.
(c) a backplane module for interconnecting said controller module and said solid state drive modules comprising:
i. a printed circuit module;
ii. a connector for receiving said controller module;
iii. a plurality of connectors for receiving said solid state disk modules;
wherein said solid state mass storage subsystem is contained in an enclosure that has a form factor equivalent to that of a single conventional disk drive such that said storage sub-system is configured for replacing a disk drive in a computing device.
